(19) United States
(12) Patent Application Publication
(10) Pub. No.: US 2026/0329861 A1
(43) Pub. Date: Oct. 22, 2026

(54) A Hybrid Data Management Method and a System for Handling Queries

(71) Applicant: OrbDB Labs AB, Stockholm (SE)

(72) Inventors: Paris Carbone, Stockholm (SE); Sonia-Florina Horchidan, Sollentuna (SE)

(21) Appl. No.: 19/486,225

(22) PCT Filed: May 24, 2024
(86) PCT No.: PCT/EP2024/064407

§ 371 Date: Nov. 20, 2025

(30) Foreign Application Priority Data
May 25, 2023 (SE) 2350636-3

(51) Int. Cl. G06F 16/2453; G06F 16/901

(52) U.S. Cl. CPC G06F 16/24542; G06F 16/9024

(57) ABSTRACT

The disclosure regards a computer implemented method for handling queries from a user, the method comprising the steps of reading the query by using a query parser, choosing an optimal way of processing the query by utilizing an uncertainty value provided by the user and a hybrid query optimizer to provide a search strategy, based on the search strategy of the hybrid query optimizer, using a Machine Learning-based query executor to traverse at least a part of a data storage and utilize at least a part of an embedding storage, wherein the data storage comprises base data stored in a graph format and the embedding storage comprises supplementary generated data for at least a part of the base data, wherein the supplementary generated data have been generated using Machine Learning, and returning a query result to the user based on the uncertainty value and the search strategy.

The present disclosure relates to a novel graph database that provides query answers on incomplete graphs.

### BACKGROUND

The state of the art in conventional database solutions for data management can be time-consuming depending on the complexity of the query. In most cases, they might be unable to provide an informative, complete response to the query due to incomplete data in the data storage. These challenges especially plague graph databases due to their inherent tendency towards sparsity and massive scale. A way of handling these challenges can involve Machine Learning-based tools for uncovering patterns and correlations to generate relevant data and approximate query answers for a given data storage.

However, incorporating such methods into data management solutions sacrifices reliability; introducing Machine Learning-based inference into query systems undermines their adoption because of the perceived lack of trustworthiness.

Therefore, a novel data management solution should be developed that can address the reliability challenges of Machine Learning-based inference in query systems.

### SUMMARY

The present disclosure relates to, according to a first embodiment, a computer implemented method for handling queries from a user, the method comprising the steps of: a) reading the query by using a query parser, b) choosing an optimal way of processing the query by utilizing an uncertainty value provided by the user and a hybrid query optimizer to provide a search strategy, c) based on the search strategy of the hybrid query optimizer, using a Machine Learning-based query executor to traverse at least a part of a data storage and utilize at least a part of an embedding storage, wherein the data storage comprises base data stored in a graph format and the embedding storage comprises supplementary generated data for at least a part of the base data, wherein the supplementary generated data have been generated using Machine Learning, and d) returning a query result to the user based on the uncertainty value and the search strategy. In addition, the data storage may be stored in a conventional backend database, where parts of the query can be retrieved using regular computational methods. The data storage may comprise base data stored as a graph either using a relational data model, a property graph data model, or any other variations which can be used to represent a graph. The uncertainty value provided by the user may be either set at the level of a global query, or at the level of a subquery, such as at a local level of a suboperation of the query. For example, if a query comprises a plurality of linked queries-subqueries-, then different threshold values may be used for one or more parts of the query.

As described in the detailed description of the present disclosure, the search strategy may relate to choosing an optimal execution strategy of the method that can satisfy the threshold value provided by the user, while also minimizing the expected execution time of the query.

One idea of the present disclosure is to provide a method that can access information from a database faster than conventional databases can handle, and possibly with more enriched query results. The way conventional databases work involves traversing the data storage to match the entries of the query with the aim to retrieve a complete query result. That method can be vastly inefficient in terms of execution time and resources. Additionally, it is often the case that databases are incomplete, or that complicated traversals are required to reach the required information. Moreover, the present disclosure may partially traverse the data storage, and partially utilize a vector storage, which stores vector representations of a given graph, such as knowledge graphs of the data storage, in conjunction with trained Machine Learning models. Machine Learning models can be trained on a given graph to accommodate the logic of respective discrete operator types that are commonly used in graph queries. A knowledge graph may be formally defined as a set of triples (h, r, t) with h and t defining entities and r representing the relation between them. Knowledge graphs have the advantage of flexibility; their structure allows the representation of any knowledge base, regardless of topic and origin. The present disclosure is not limited to knowledge graphs, as the data may also be stored in other generic graph data models, such as property graphs, or in relational models. In any part of the present disclosure where a knowledge graph is disclosed, a generic graph or another data representation, such as relational models capturing graph relationships can also be used.

Unlike traditional data that conforms to Euclidean geometry, graph-like data has the potential to carry information that extends beyond intrinsic node properties. The topology around a node might sometimes reveal more informative insights than the node itself. The capability to use a hybrid method, which can both traverse a data storage and utilize an embedding storage can infer missing information. This approach can significantly lower the computational cost and the response time of a database management system.

In addition, this method allows the user to provide an uncertainty value, which reflects an upper bound of uncertainty that a user would be satisfied with, for example, 5%, and the method would then design a way of executing a query by jointly traversing the base data and the supplementary generated data, to limit the uncertainty value at the said upper bound while keeping the cost as low as possible. Cost in the context of the present disclosure may refer to the time it takes for the method to process the query and provide a query result. More information about the cost value and how it is integrated to the model is disclosed in the detailed description.

Furthermore, in order to optimize the model in terms of time efficiency, the base data in the data storage that are stored in a knowledge graph format comprise a plurality of nodes and edges. In addition, the supplementary data in the embedding storage may be compressed vector representations of nodes, edges, and/or subgraphs of the data storage.

The method can be further configured, such that the embedding storage is continuously supplemented with additional supplementary data based on the data storage. This feature allows the model to generate valuable vector representations of the base data in the data storage, which may be used for queries provided by the user.

Moreover, the cost value can be used by the hybrid query optimizer to enumerate candidate hybrid plans, which are used to find the optimal cost for a given uncertainty threshold for a specific query provided by the user. The cost function reflects the time needed for the method to provide a query under a given uncertainty value.

In summary, the present disclosure can be a powerful tool for a number of applications, as it can allow on-demand fast and efficient query results, which may also be based on inferred results, with the crucial customization of the search based on an uncertainty bound provided by the user, depending on the situation. This solution holds significant advantages over existing state of the art methods, as it does not only rely on a data storage, but also on vector representations of the data storage. Last but not least, the candidate hybrid plans may allow the method to tailor a strategy of traversing data for any query, depending on the uncertainty value and the data completeness of the data storage on the topic of the query.

### DESCRIPTION OF DRAWINGS

Various embodiments are described hereinafter with reference to the drawings. The drawings are examples of embodiments and are intended to illustrate some of the features of the presently disclosed hybrid data management method and system for handling queries, and are not limiting to the presently disclosed system and method.

FIG. 1 shows a schematic of the steps disclosed in the database management method.

FIG. 2 shows a schematic providing further information about the hybrid query optimizer.

FIG. 3 shows a schematic illustrating the way that a Machine Learning-based query executor can retrieve information from a data storage and an embeddings storage, as well as the training of data and writing of new embeddings in the embeddings storage.

FIG. 4 shows a schematic illustrating the way the candidate hybrid plans are evaluated to choose the optimal search strategy, which would satisfy the uncertainty value at the smallest cost value possible.

FIG. 5A, B shows an example of a query given by a user and examples of candidate hybrid plans with their corresponding uncertainties and costs.

FIG. 6 shows different examples of customization strategies that can be imposed by the user.

FIG. 7 shows the hybrid execution strategy flow of logic, using both conventional database execution and Machine Learning-based execution.

FIG. 8 shows a potential logical plan corresponding to a query with local uncertainty thresholds.

FIG. 9 shows a schematic of the various components of the proposed data management solution.

FIG. 10A, B shows an example of a query given by a user which can predict an uncertainty value, and examples of candidate hybrid plans with their corresponding uncertainties and costs.

### DETAILED DESCRIPTION

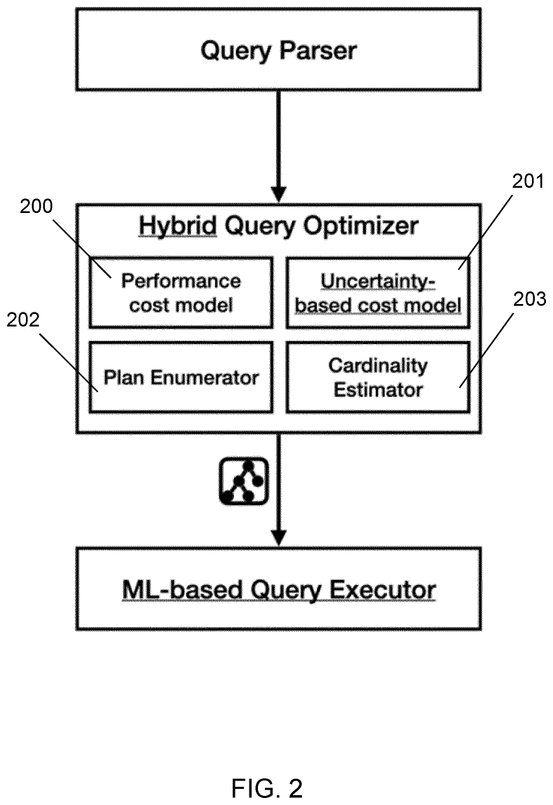

The present disclosure relates to a computer implemented method for handling queries from a user, the method comprising the first step of a) reading the query by using a query parser. The query parser can operate similarly to a traditional parser in a conventional database system. One difference can be that the query parser in the present disclosure can be extended to support uncertainty bounds, which are the uncertainty values provided by the user. The next step of the method is to b) choose an optimal way of processing the query by utilizing an uncertainty value provided by the user and a hybrid query optimizer to provide a search strategy. The uncertainty values can be a way to determine the error magnitude that the user imposes. Depending on the uncertainty value, the hybrid query optimizer can act accordingly, to find a query execution plan that can provide a query result at the fastest time with error less than the user-defined uncertainty thresholds. In traditional database management systems, the optimization flow is to enumerate all the possible physical plans and choose the cheapest one using operator cardinality estimation techniques. However, in the present disclosure, the hybrid query optimizer can search for the optimal physical query plan (also written as search strategy), given that certain operations can be executed either on raw graph data in the data storage, or as Machine Learning inference calls in the embedding storage. However, introducing inference into the query execution comes at the cost of increased uncertainty in query results, since Machine Learning models are traditionally evaluated on historical data and cannot provide any guarantee for future, unseen data points. The optimization, in this case, can be built around two cost functions: one to find the most efficient query plan (i.e., a performance-based cost model, also written as cost herein) and one to guarantee the user-defined error threshold (i.e., an uncertainty-based cost model, corresponding to the uncertainty value). Therefore, the search strategy is based on the optimal choice of the two functions encompassing speed and uncertainty bounds. The hybrid query optimizer may also comprise a plan enumerator and a cardinality estimator, which may operate as they operate in traditional database management systems. Specifically, the plan enumerator can generate and evaluate the different search strategies, based on the performance cost model and the uncertainty-based cost model, and choose the optimal search strategy. The cardinality estimator can estimate the number of rows that will be returned by a given query. The number of rows refers to the number of possible results of the given query. One purpose of the cardinality estimator can be to provide reliable estimates of the query result size, given that some query parts can be inferred, which can then be utilized by the plan enumerator to generate the search strategies. An embodiment of a hybrid query optimizer is shown in FIG. 2, comprising a performance cost model 200, an uncertainty-based cost model 201, a plan enumerator 202 and a cardinality estimator 203. Using the above tools the hybrid query optimizer can find the optimal search strategy.

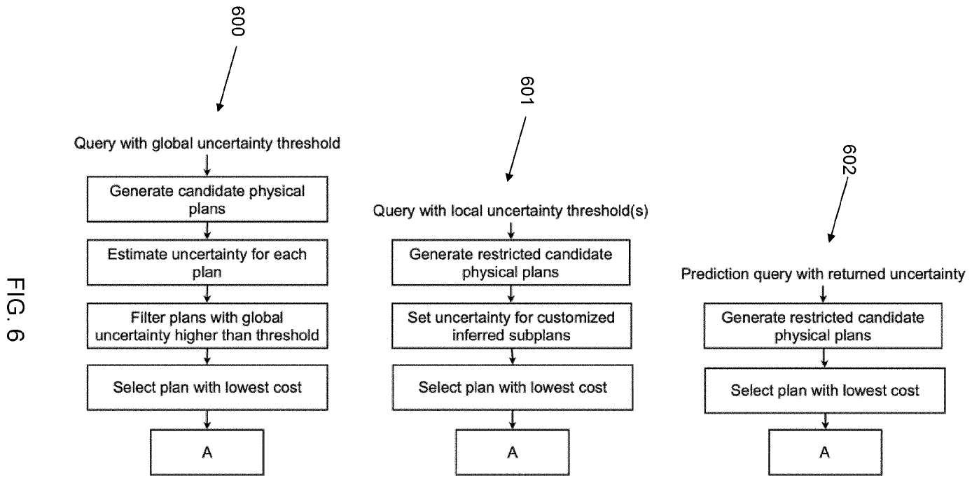

In an embodiment, the optimization process may be guided by the user, who may set a global uncertainty level on the query, as seen in FIG. 6 600. It is also possible that the user may set local uncertainty thresholds in subqueries 601, or the user may let the optimizer to find the optimal trade-off between uncertainty and lowest cost (or execution time), and request the resulted uncertainty to be returned 602. Such options provide vast versatility to a user, who can decide depending on the type of query what type of strategy can be followed. In some cases, it may be beneficial to provide a global uncertainty threshold, or a series of local uncertainty threshold, for example related to some critical aspects of the query. For instance, a global uncertainty threshold can be provided by a 10% uncertainty threshold, while a local uncertainty threshold of 2% can be provided on an aspect of the query that may require high accuracy. The above phrasing would relate to introducing an uncertainty threshold at a global level of the query, or at a local level of the query. Note that in the present disclosure, the term “uncertainty value” is equivalent to the term “uncertainty threshold”.

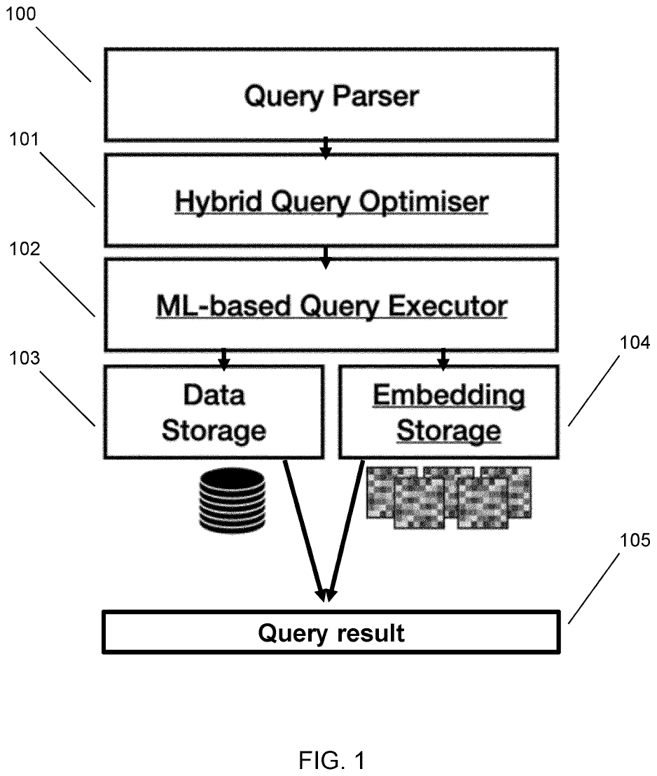

After the hybrid query optimizer has found the optimal search strategy, the next step of the method follows. c) Based on the search strategy of the hybrid query optimizer, a Machine Learning-based query executor can be used to traverse at least a part of a data storage and utilize at least a part of an embedding storage. The data storage comprises base data stored in a graph format and the embedding storage comprises supplementary generated data for at least a part of the base data, wherein the supplementary generated data have been generated using Machine Learning. In a traditional database management system, a query optimizer would find the optimal query plan, and then the executor would complete the plan and traverse the graph data using the data storage component. However, in the present disclosure, the query executor does not exclusively traverse data from the data storage, but it may also utilize data from the embedding storage, which involves generated vector representations based on the data storage, referred to as embedding storage. The proposed system maintains Machine Learning models that are trained on data storage, such as deep neural networks which may generate data representations in the form of compressed vector representations of the graphs stored in the data storage. Then, the trained vector representations are written to an embeddings storage when the training is complete, and they can be part of the query execution process. Finally, the final step comprises d) returning a query result to the user based on the uncertainty value and the search strategy. After the query executor has executed the search strategy, a query result that satisfies the uncertainty value with as small speed cost as possible can be returned to the user. An embodiment of the steps disclosed in the database management method can be seen in FIG. 1. A query parser 100 can handle a query by a user, and a hybrid query optimiser 101 to provide a search strategy based on the uncertainty given by the user. After the optimal search strategy is found, a Machine Learning-based query executor 102 can be used to traverse at least a part of a data storage 103 and utilize at least a part of an embedding storage 104. The final step is to return a query result 105 to the user based on the uncertainty value and the search strategy.

It should be noted that the present disclosure is not limited to knowledge graphs, as the data may also be stored in other generic data models supporting graphs, such as property graphs or relational data. In the present disclosure, the query executor may not exclusively traverse data from the data storage, but it may also utilize data from a vector storage, which involves generated vector representations based on the data storage, referred to as embedding storage. The proposed system maintains Machine Learning models that are trained on data storage, such as deep neural networks which may generate data representations in the form of compressed vector representations of the graphs stored in the data storage.

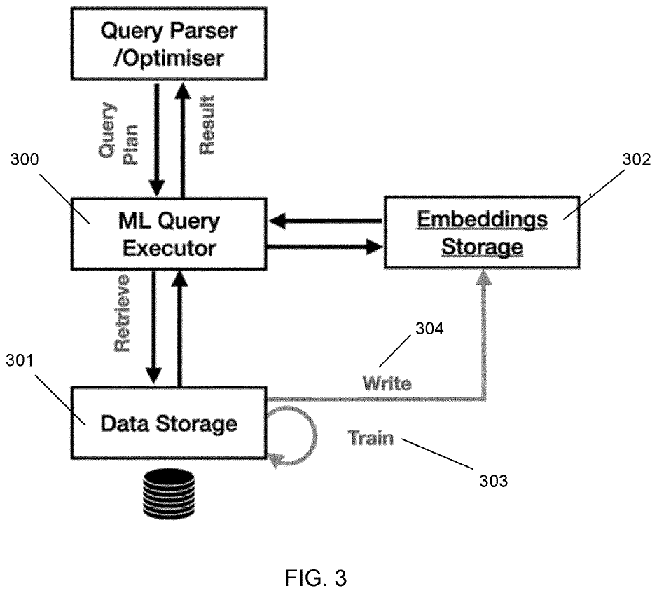

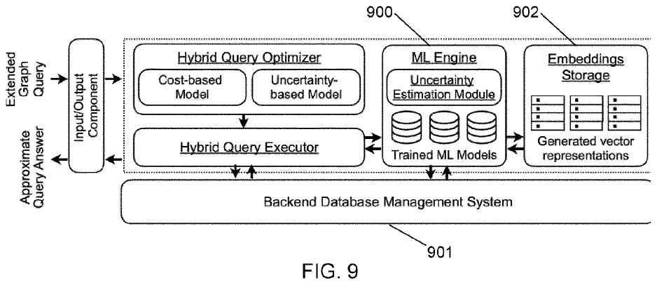

An embodiment of the query executor can be seen in FIG. 3 wherein the query executor 300 can traverse data from the data storage 301, and utilize the embedding storage 302, which involves simulated data based on the data storage. The embedding storage maintains Machine Learning models that are trained 303 on the data storage. Then, the trained vector representations are written to an embeddings storage 304 when the training is complete, and they can be part of the query execution process. In an embodiment shown in FIG. 9, the Machine Learning engine 900 maintains the Machine Learning models that are trained on the data storage, and the embedding storage maintains data representations obtained in the process. In this example, the Machine Learning-based query executor may traverse at least a part of a data storage and utilize at least a part of an embedding storage, by accessing the backend database management system 901 and embeddings storage 902 respectively.

In another embodiment, the method can comprise the step, wherein the query result is stored as new data in incomplete knowledge graphs of the data storage. For example, apart from only returning the query to the user, the method may also be configured to store the query result in knowledge graphs of the data storage, which are missing certain information. This feature may be useful for future queries, as it can enhance the efficiency of the method by producing queries with a smaller cost. These query results may be produced with an uncertainty value, which would mean that they might contain incorrect information. Therefore, the method can take that into account when traversing knowledge graphs that include such information, to correctly estimate the uncertainty of the future query results.

Furthermore, the uncertainty value can comprise a global uncertainty value set at a global level of the query, and/or a local uncertainty value, set at a local lever of the query. For example, if a query comprises a plurality of linked queries-subqueries-, then different threshold values may be used for one or more parts of the query. In the examples section, FIG. 6 is described, where it discloses different approaches using a global uncertainty threshold or local uncertainty threshold(s).

Moreover, the method can comprise the step, wherein the base data in the data storage that are stored in a knowledge graph format comprise a plurality of nodes, edges and potential features. The nodes can represent various entities, while the edges can represent the relationship between different entities. The features may represent attributes or properties associated with individual nodes or edges in the graph. A node can have more than one edges, meaning that it can relate information to more than one node. For example, a node can comprise an entity in the graph with the label “Stockholm”, and it can be connected to another node “Sweden” by the edge “capital of”, but it may also be connected to the node “Europe” by the edge “city of”.

The node with the label “Stockholm” may also contain a set of features. For example, it may store the population of the city. The edge “capital of” may also store, for example, features specified to the year where the city was elected as capital. Extending this reasoning, multiple pieces of information on any topic can be connected with one another by this smart way of managing data. The underlying data model chosen to represent the above graph data is one possible way of representing graph data, as various graph formats can be applied in the present disclosure.

In addition, the method can comprise the step, wherein the supplementary data in the embedding storage are compressed vector representations of all the nodes of the data storage. By vector representations, we refer to a mathematical encoding of the information resulting from training specialized Machine Learning and deep learning models on graph data, such as knowledge graphs, by storing for example information in a matrix format. This way of storing the supplementary data can be more efficient than storing in a knowledge graph format, since it can be a convenient way of organizing data.

Furthermore, it can be possible to apply Machine Learning and/or deep learning methods on the embedding storage, allowing the system to find novel correlations in the base data and discover new insights that can go beyond the explicit information that is provided by the base data. As a result, this process can aid in alleviating the challenges of incomplete knowledge graph databases.

In one embodiment, the method can comprise the step, wherein the embedding storage is continuously supplemented with additional supplementary data based on the data storage. The embeddings can be continuously generated by maintaining Machine Learning and/or deep learning models that are trained on the data storage. The trained vector representations are written to an embedding storage when training completes. These steps can potentially occur when the database is set up with initial data and they can be performed regularly to keep the Machine Learning models updated. This feature can have the advantage of preparing vector representations of the data storage in advance, and when a user provides a query, the embedding storage may already have the relevant information to return a query result. When the data storage is enriched with new data, then the above process may be applied, generating new vector representations of the new data by maintaining the Machine Learning and/or deep learning models that are trained on the new data. As a result, this feature can further enhance the efficiency of the model, by providing more accurate results.

Furthermore, the method can further comprise the step, wherein the query has any graph query language format. The method has the versatility to accommodate a plurality of graph query languages. Examples of some graph query languages that can be used are GQL, Gremlin, SQL, Prisma, Oracle PL/SQL, Cypher, AQL, SPARQL. Each language has certain advantages and disadvantages, depending on the topic that they are applied. As a result, depending of the application of the current disclosure, a different graph query language can be used for the queries. An example of a query given by a user written in Cypher language can be:

PREDICT (TH:Person {name:
‘Tom Hanks’})-[d:DIRECTED]->(M:Movie)
-[nf:NOMINATED_FOR]->(A:Award)
RETURN A
WITH MAXIMUM UNCERTAINTY 0.05;

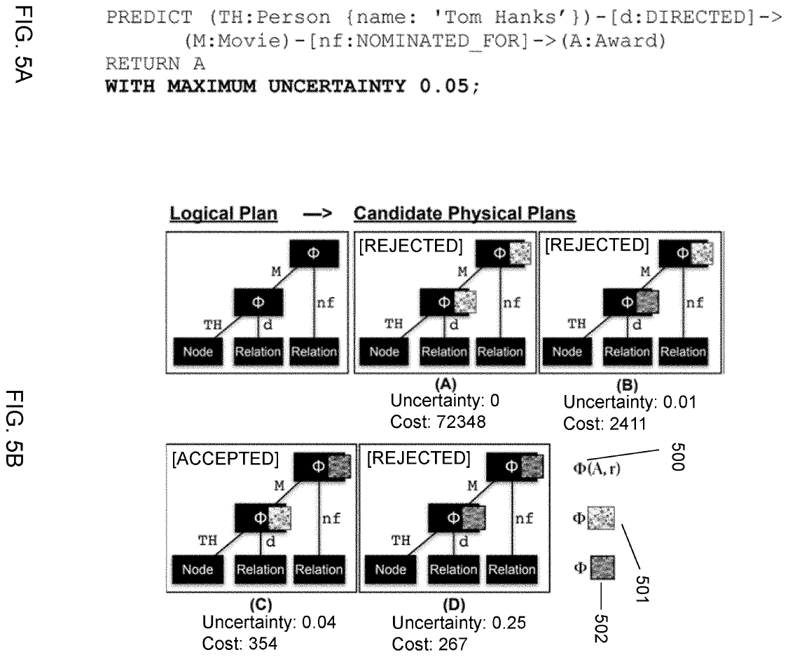

In the above example, a query is provided that asks the model to process the movies who have been nominated for an award where Tom Hanks has been the director of. In this example of query language, the dashes in the query can represent a link between two pieces of information, such as the movie that is nominated for something. The arrows represent a relationship between two pieces of information, such as an award that the movie is nominated for. The aim of this query is to find all the awards “A” that satisfy the aforementioned parameters, with an uncertainty less than 0.05. The uncertainty value will influence the result of the search strategy, as it dictates the amount of traversals performed on the data storage and on the operations performed in the embedding storage. It may also be possible to request more than one pieces of information using, and possibly add different uncertainties of each one. In the example given above, the movies “M” may also be returned, and the user may use the same or a different uncertainty value for that quantity. This query shows an example of a global uncertainty threshold of 0.05 set by the user. The uncertainty value will influence the result of the search strategy, as it dictates the amount of traversals performed on the data storage and on the operations performed in the embedding storage. The user may modify the query and the uncertainty value arbitrarily. FIG. 5B shows a possible query optimization process, there the system enumerates multiple candidate plans, computes their uncertainty level using an Uncertainty Cost model, where an uncertainty cost model can be a component computing or setting the uncertainty of each Machine Learning model inference. Then, the system may selects the candidate plan that satisfies the global uncertainty threshold, and has the lowest estimated IO cost, which could have been estimated using the cost model. The global threshold allows the system to choose which traversal steps flexibly it can approximate using Machine Learning and which it can execute explicitly, as shown in FIG. 5B.

Another example of a query given by a user and written in Cypher language can be:

```
MATCH (p:Person)-[r:REPRESENTS]->(t:Team)
WHERE p.name = ‘Risa Shimizu‘
PREDICT (t)-[pi:PLAYED_IN]->(m:FootballMatch)
    -[it:IN_TOURNAMENT]->(tt:Tournament)
  WITH MAXIMUM UNCERTAINTY 0.02
PREDICT (p)-[rr]-(tt)
  WITH MAXIMUM UNCERTAINTY 0.03
RETURN type(rr);
```

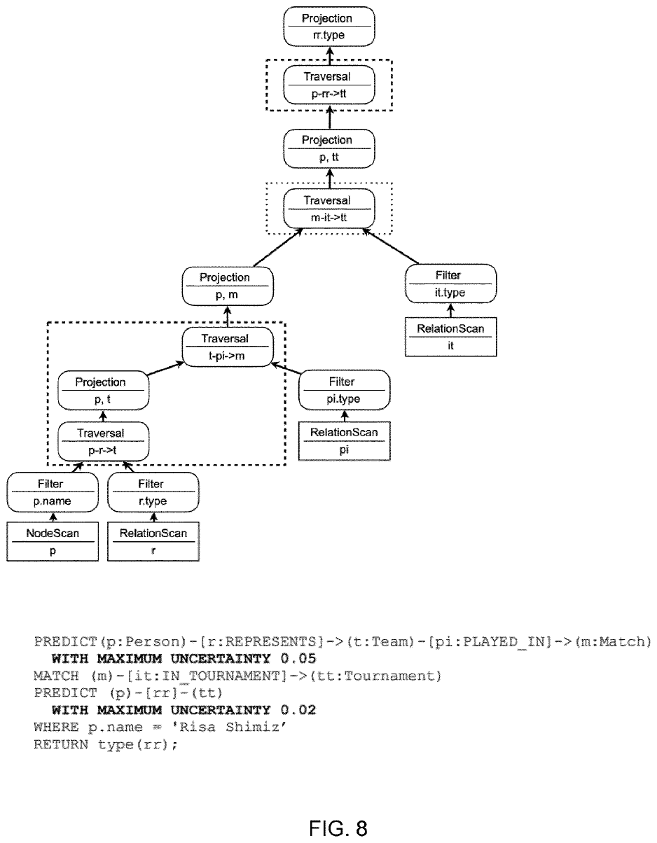

In the above example, a query is provided that asks the system to find all the teams represented by Risa Shimizu. The user wants the system to use the trained models to approximate the tournaments containing football matches where Risa's team played. The user sets an error bound of 2% for this step. Further, the user asks the system to predict the types of relations between Risa and these tournaments with an error of a maximum of 3%. These relations are returned to the user. In this query, the user sets declaratively which parts of the query should be approximated (i.e., using the PREDICT keyword) and which should be executed explicitly on the data storage (i.e., using Cypher's MATCH keyword in this example). The user declaratively sets the error bound for these steps. The above example illustrates how the local uncertainty value can be applied in a query by a user. FIG. 8 shows possible equivalent inference calls that can be used for ML approximation for the different operators, and equivalent Cypher queries used for the explicit execution. The figure shows how the maximum uncertainty thresholds are set to match the user preferences in the query.

A further example of a query given by a user and written in Cypher language can be:

PREDICT (TH:Person {name:
‘Tom Hanks’})-[d:DIRECTED]->(M:Movie)
-[nf:NOMINATED_FOR]->(A:Award)
RETURN A, UNCERTAINTY(A);

In the above example, a query is provided that asks the system to predict all the awards that nominated movies directed by Tom Hanks. The user requires the uncertainty thresholds to be returned. In this case, the optimization process can enumerate candidate physical plan and, for example, select a plan that strikes a balance between the estimated IO cost and the uncertainty threshold. The query will return the results obtained in the execution alongside a resulted uncertainty value. The dashes in the query may represent a link between two pieces of information, such as the person that represents a team. The arrows represent a relationship between two pieces of information, such as a team playing a football match.

It should also be noted that the current disclosure may comprise the step, wherein certain operators of a query can be carried out in the embedding storage, while others can be carried out in the data storage. For example in the first query case shown above, the first set of operators can be performed on the data storage (Tom Hanks, Directed, ?), while the second set of operators can be performed on the embedding storage using Machine Learning-based inference (Movies, nominated_for, ?). Depending on the cost of each operator, and the uncertainty caused by performing an operator on the embedding storage, there can be alternative ways of performing the operators for each query. This can result in a hybrid mix of raw data operations and embedding-based ones, which can be an important feature allowing lower computation cost and lower response time in comparison with traditional database management systems.

Moreover, the method can comprise the step, wherein the query comprises a plurality of operators that execute on a knowledge graph, such as node distance approximates. For example, a shortest path operator may be used, which can find the shortest path between two nodes in a knowledge graph. The node distance operator can also be useful, as it can calculate the distance between two nodes in a knowledge graph in terms of the number of edges between the two nodes, or also in other metrics, such as the semantic link between two nodes. Another example is the node centrality operator, which can calculate with how many other nodes is a specific node linked with. As a person skilled in the art would know, there are much more operators which can be applied in a query to act on knowledge graphs. Depending on the case and the type of the query, different operators could be applied. For example, the node distance approximation can be used to offer an approximation of the distance between two nodes, instead of traversing the whole knowledge graph.

In another embodiment, the method can comprise the step, wherein the uncertainty value has limits from 0 to 1, and it is preferably less than 0.5, more preferably less than 0.35, even more preferably less than 0.25, most preferably around 0.05 and 0.15, preferably around 0.1. An uncertainty value of 0 would mean that the user requests no error for the query result. That would lead into the model traversing exclusively on the data storage, which would naturally increase the cost value of the search strategy and would potentially lead to incomplete query answers. On the other hand, an uncertainty value of 1, would mean that the user is not concerned about the error of the query result, and that would lead to the method operating almost exclusively on the embedding storage.

The uncertainty value can also be considered as a percentage of error that a user can be satisfied with. For example, a user may provide a query for which the user would require a very high accuracy. Therefore, the user in that case can use an uncertainty of 0.05, which would mean that the query result given by the model would have an error of equal or less than 5%. If the query result is a number, then the number can have an error of 5%, while if the error is a word, or a sentence, the uncertainty can be thought as a chance that the query result is false. The larger the uncertainty value, the higher the chances that the model provides a false query result, but the cost value would decrease significantly, meaning that the model can provide a query result faster, since it would be allowed to operate more in the embedding storage and less in the data storage.

Moreover, the method can comprise the step, wherein the uncertainty value determines the amount of processes performed by the computer implemented method on the data storage and on the embedding storage. The reasoning behind that is, as described in the previous paragraphs, that the data storage contains data, which are verified and known, therefore if the model would traverse exclusively on the data storage, then the query result would be correct, provided that the data storage is complete for the given query. However, traversing in the data storage can increase the cost value of the search strategy, as it is more time consuming than operating on the supplementary generated data in the embedding storage, where the supplementary generated data are vector representations of the base data. Specifically, the vector representations can be used together with Machine Learning models to approximate results of various query types. These vector representations may contain some untrue information, but they come with the advantage that utilizing the vector representations in the embedding storage is faster than traversing the data storage. As a result, the balance between choosing to traverse in the data storage or operate in the embedding storage can be dictated by the uncertainty value, as a lower uncertainty value would reflect more traversing on the data storage and less utilization of the vector representations in the embedding storage. On the other hand, a higher uncertainty value would reflect less traversing on the data storage and more utilization of the embedding storage.

In addition, the method can comprise the step, wherein the embedding storage comprises supplementary generated data based on incomplete knowledge graphs of the data storage. For example, as the process of generating supplementary data in the embedding storage is continuously performed, the embeddings can also generate data from incomplete knowledge graphs of the data storage, and these data could be used on-demand for future queries, reducing the cost of queries. It can be especially useful to generate vector representations in the embedding storage of incomplete knowledge graphs of the data storage, as the incompleteness of databases is one of the main obstacles in the way of having fast and correct query results. Therefore, the above step can assist in a more optimal way of handling queries and getting query results. In addition, the vector representations in the embedding storage may be used to generate results with enriched connectivity and properties that may not have existed in the original knowledge graphs of the data storage. For example, the vector representations may reveal novel correlations among data that were not identified in the data storage. That feature can boost further the applicability of the present disclosure, as it can be used as a tool of identifying correlations among data in knowledge graphs of large databases.

In another embodiment, the method can comprise the step, wherein a cost model is included in the search strategy of the hybrid query optimizer, which reflects the time needed for the method to provide a query under a given uncertainty value. As it has also been described in the previous paragraphs, a cost function can be included in the system which gives information regarding the time it would take for the system to provide a query result, for a specific query plan, referred to as IO cost. As a result, the cost function can be an important feature of the present disclosure, as it allows the hybrid query optimizer to assess different types of search strategies (where each search strategy corresponds to a specific amount of traversals in the data storage and utilization of the embedding storage), and it can come up with a cost value which would reflect the time required to complete a query.

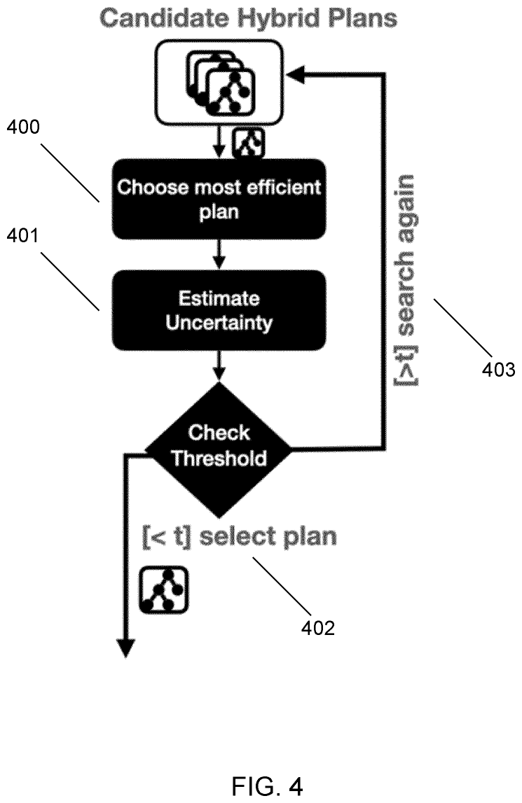

The cost function can be coupled with the uncertainty value provided by the user to assist the hybrid query optimizer into choosing an optimal search strategy. Specifically, the method can further comprise the step, wherein the hybrid query optimizer enumerates candidate hybrid plans, which find the optimal cost for a given uncertainty value for a specific query provided by the user. The candidate hybrid plans can be thought as search strategy candidates, which can take as input the query provided by the user, and they can find the most efficient plan, which refers to a search strategy with the smallest cost value. Then, as that search strategy may involve traversing parts of the data storage or operating on vector representations in the embedding storage in conjunction with trained Machine Learning models, it may have a finite uncertainty value, which can be calculated. If that uncertainty value is less than the uncertainty value provided by the user, and if there is no other candidate hybrid plan with lower expected cost value that still satisfies the uncertainty value, that particular candidate plan is chosen as the optimal plan, and it will become the search strategy, which can be then used by the machine learning-based query executor. However, if the uncertainty value is larger than the uncertainty value provided by the user, then the current candidate hybrid plan is abandoned, and a new search for another plan is performed, until the uncertainty criterion is satisfied. It should be noted that the above is one example of how the candidate hybrid plans can be set. The order in optimisation might defer depending on the optimiser implementation. For example, in another embodiment, the uncertainty value could be estimated first, and then the cost value could be optimised, or alternatively, multiple combinations of uncertainty and cost values could be assessed in parallel, speeding up the computation of the method. An embodiment of the candidate hybrid plans can be seen in FIG. 4. Each candidate hybrid plan can have as input the query provided by the user, and each candidate hybrid plan will attempt to find the most optimal plan in terms of efficiency (cost value) 400 and uncertainty 401. If these criteria are satisfied, the plan is selected 402 and is forwarded to the Machine Learning-based query executor. If the criteria are not satisfied, then another candidate hybrid plan is searched 403 until the criteria are fulfilled. In the scenario that the uncertainty value cannot be satisfied, then a search strategy comprising traversals only on the data storage can be chosen, which will reflect a candidate hybrid plan with uncertainty equal to zero, since no operations on the supplementary generated data will be performed.

In an alternative case, it can be possible for the method instead of choosing only one search strategy, to provide several search strategies which all of them would satisfy the uncertainty value given by the user, but they would have slightly different cost and uncertainty value combinations. This could be for example helpful, if the user would want to crosscheck the query result, by having different query results with lower uncertainty. Naturally, the above would increase the computation time of the model, but it could be applicable in certain cases.

Moreover, the method could comprise the step for the case that the user has not provided an uncertainty value, wherein the hybrid query optimizer attempts to find a search strategy that minimizes the cost function, while at the same time keeping the uncertainty value to reasonable values, such as less than 20%. The method could also provide additional query results with higher or lower uncertainty values. This can be a useful option in the scenario that the uncertainty value is not essential for the user, and the model can then attempt to strike a balance between the cost value and the uncertainty value to provide a query result in reasonable time.

The present disclosure further relates to a query handling system comprising a server unit for storing data, and a processing unit configured to:
a) Obtain a query,
b) Choose an optimal way of processing the query by utilizing an uncertainty value provided by the user and a hybrid query optimizer to provide a search strategy,
c) Based on the search strategy of the hybrid query optimizer, use a Machine Learning-based query executor to traverse a part of a data storage and utilize at least a part of an embedding storage, wherein the data storage comprises base data stored in a graph format and the embedding storage comprises supplementary generated data for at least a part of the base data, wherein the supplementary generated data have been generated using Machine Learning, and
d) Return a query result to the user based on the uncertainty value and the search strategy.

The system may include a memory, such as a random access memory (RAM) and/or a read-only memory (ROM), or any suitable type of memory. The system may further comprise a communication interface that allows software and/or data to be transferred between the system and external devices. Software and/or data transferred via the communications interface may be in any suitable form of electric, optical or RF signals. The communications interface may comprise, for example, a cable or a wireless interface.

The present disclosure further relates to a computer program having instructions which, when executed by a computing device or computing system, cause the computing device or computing system to carry out the method of handling queries from a user according to any of the information provided in the summary and the detailed description of the present disclosure. The computer program may be stored on any suitable type of storage media.

In an embodiment, the method for handling queries from a user may relate to obtaining the query parsed by a traditional query parser, and obtaining uncertainty thresholds set by the user either declaratively in an extended query language or via a graphical interface, wherein the uncertainty thresholds can be either set at the global level of the query or on a granular level for each suboperation, and the extension of the query language allows the user to declare which parts of the query should be approximated. In addition, the method may choose an optimal way of processing the query by utilizing the uncertainty thresholds provided by the user, and a hybrid query optimizer to provide a search strategy. Based on the search strategy of the hybrid query optimizer, a Machine Learning-based query executor and an embedding storage may be used to infer parts of the query, wherein a generic backend database may store the base graph data to execute parts of the query in a conventional way. Then, the method may obtain a query result containing the inferred answers that are likely to be the correct answers to the query, under the uncertainty thresholds provided.

### Examples

An embodiment of a query given by a user and the candidate hybrid plans related to it can be seen in FIG. 5A, B. The query is a two-hop Cypher query example, where the first-hop is (Tom Hanks, Directed, ?) and the second-hop is (Movies, nominated_for, ?). This query searches for all the award nominations for movies directed by Tom Hanks with a maximum allowed error of 5%. In this example, the query optimizer identifies four candidate hybrid plans. Plan A is the plan with only traditional, explicit operators. Plans B and C contain a mix of embedding-based and raw data operators, while plan D operates entirely in the embeddings latent space. Latent space refers to the reduced worst-case complexity space of operations that is enabled by the compressed vector representations of the embedding storage. In many cases, the complexity of latent space operations is only proportional to the number of computational steps in the query, and is unaffected by the size of the knowledge graph. Plan A has no uncertainty because it traverses raw data. However, the optimizer rejects it due to the high estimated processing cost. Plan B performs the first hop (Tom Hanks, Directed, ?) in the latent space and the second hop (Movies, nominated_for, ?) by following the real data pointers. Although this plan's uncertainty is adequate, it is rejected due to its higher cost. Plan C performs the first hop on raw data and the second hop in the embedding space. This plan shows the lowest cost value at an acceptable uncertainty level. Plan D breaches the user-defined uncertainty constraint and is, thus, rejected. The cost optimizer identifies plan C as optimal for the given query. Yet, if aiming to strike a balance between uncertainty and efficiency, Plan B could also be considered a good candidate. In FIG. 5 B, the φ(A, r) operator 500 relates to a traversal operator starting from node A and following relation r. The symbol 501 relates to a data storage traversal operator that follows explicitly stored links. The symbol 502 relates to a Machine Learning traversal operator backed by a link prediction model.

FIG. 6 shows different examples of customization strategies that can be imposed by the user, via for example, the query language. The first strategy 600 complements the structure shown in FIG. 4; the user may set a global uncertainty threshold for a whole query. The system is free to customize the underlying execution such that the uncertainty threshold is met. FIG. 5A shows a query corresponding to the above example.

The second strategy 601 shown in FIG. 6, shows how the user can customize the execution process, performed by the Machine Learning-based query executor. For example, the user may break down the query into multiple steps and declare which septs will be predicted and which should be executed explicitly, by using, for example, different keywords in the query language. The user may also set an uncertainty value on each of these query parts. Such a query language example is written below:

```
PREDICT(p:Person)-[r:REPRESENTS]->(t:Team)
    -[pi:PLAYED_IN]->(m:Match)
  WITH MAXIMUM UNCERTAINTY 0.05
MATCH (m)-[it:IN_TOURNAMENT]->(tt:Tournament)
PREDICT (p)-[rr]-(tt)
  WITH MAXIMUM UNCERTAINTY 0.02
WHERE p.name = ′Risa Shimiz’
RETURN type(rr);
```

The above query asks the system to find all the teams represented by Risa Shimizu. The user wants the system to use the trained models to approximate the tournaments containing football matches where Risa's team played and sent local uncertainty thresholds. The user sets an error bound of 2% for this step. Further, the user asks the system to predict the types of relations between Risa and these tournaments with an error of a maximum of 3%. These relations are returned to the user. In this query, the user sets declaratively which parts of the query should be approximated (e.g., using a PREDICT keyword) and which should be executed explicitly on the data storage (i.e., using Cypher's MATCH keyword in this example). The user declares the error bound for these steps. FIG. 8 shows a possible candidate plan generated by the system. The traversal operators correspond to different traversal steps in the query. Given the user preference, the system executes some traversal operators via Machine Learning approximation, while others are executed explicitly. FIG. 8 shows possible equivalent inference calls that can be used for Machine Learning approximation for the different operators and equivalent Cypher queries used for the explicit execution. The figure shows how the maximum uncertainty thresholds are set to match the user preferences in the query.

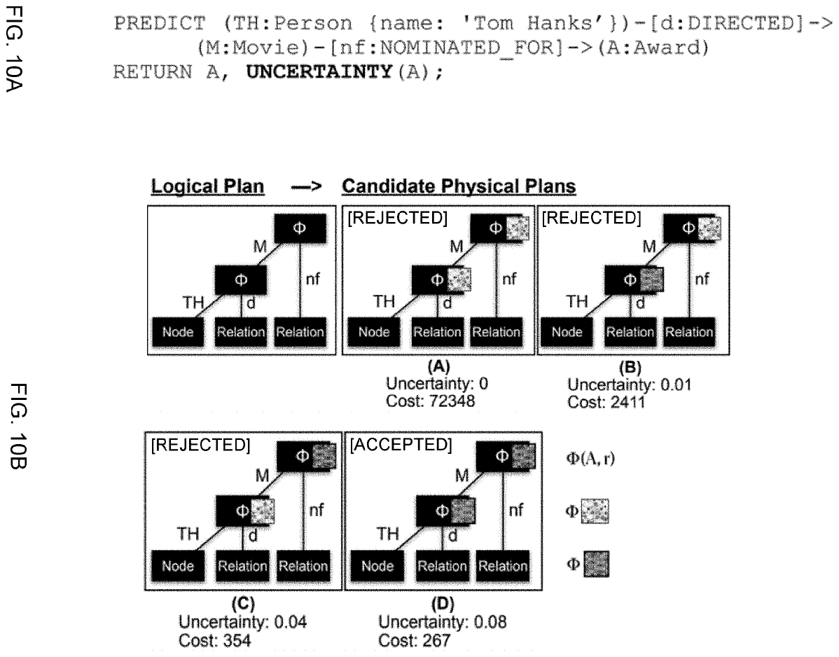

The third strategy 602 shown in FIG. 6, shows an example of a query where the user wishes to predict, but does not need to limit the uncertainty. In this case, the process returns an uncertainty value, and the user can get an understanding of how certain the predictions are. FIG. 10A shows such a query.

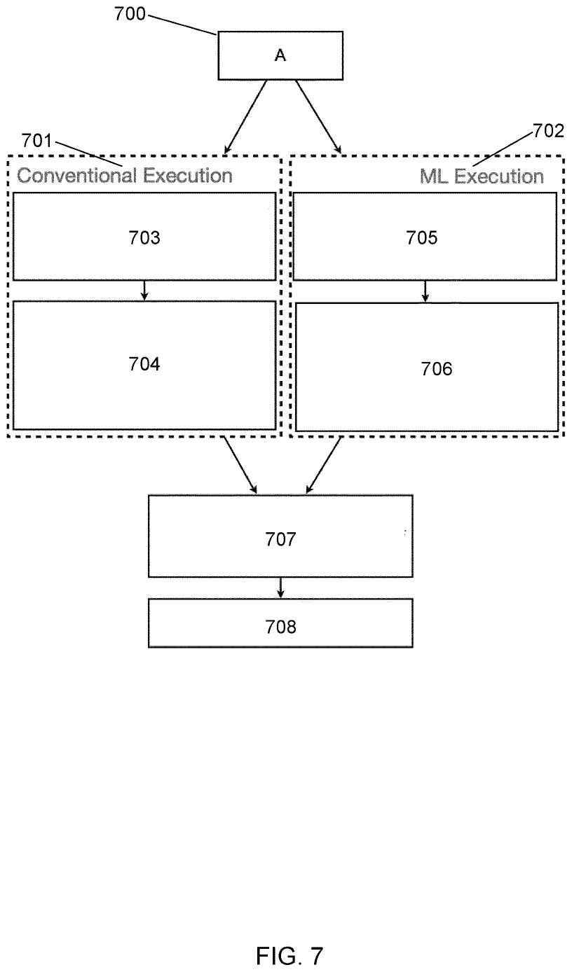

After a search strategy 700 has been selected from the different customization strategies shown in FIG. 6, the hybrid execution strategy flow of logic can be performed, where an example is shown in FIG. 7. The Machine Learning-based query executor may use both conventional database execution 701 and Machine Learning-based execution 702. The conventional database execution may comprise rewriting queries corresponding to parts of the query which will be executed explicitly according to the optimal plan (the provided search strategy) 703, and execute queries corresponding to parts of the query which will be executed explicitly in a connected database management system 704, such as the data storage. The Machine Learning execution may generate code to execute corresponding Machine Learning inference calls 705, and then execute the corresponding Machine Learning inference calls using the Machine Learning engine and a connected vector embedding storage system 706. Combining the operations above, the results obtained by the respective execution paths of the optimal physical plan (search strategy) can be collected 707, and a query result 708 with an associated uncertainty value can be returned to the user.

FIG. 9 showcases a more detailed look into the possible architecture of the present disclosure. The Backend Database Management System is a conventional data management system which can be used as the data storage. The present disclosure imposes no restriction on the chosen Backend Database Management System; the user can store their graph data in a graph database, a relational database, or any other solution of choice. The presented system complements the capabilities of this traditional data management system by providing (1) complete results obtained using Machine Learning inference, which are likely to augment true results of the user queries with generated results of high likelihood, and (2) potentially accelerated response times. The Hybrid Query Optimizer and Hybrid Query Executors are described in the previous sections of the present disclosure. A Machine Learning Engine component can potentially interact with the Hybrid Query Executor to execute the Machine Learning inferences by consulting the Embeddings Storage. The Machine Learning Engine manages the trained Machine Learning models, which are updated using data in the Backend Database management System (Data Storage). The Machine Learning Engine may also write and maintain the vector representations. The Executor also interacts directly with the Backend Database Management System to execute the explicit query subplans.

FIG. 10A shows a query similar to FIG. 5A, with the difference that in FIG. 10A the user does not set the maximum uncertainty limit allowed, but asks for the query to return it, by using, for example, a command “RETURN UNCERTAINTY (A)”.

### Further Details of the Invention

1. A computer implemented method for handling queries from a user, the method comprising the steps of:
   reading the query by using a query parser;
   choosing an optimal way of processing the query by utilizing an uncertainty value provided by the user and a hybrid query optimizer to provide a search strategy;
   based on the search strategy of the hybrid query optimizer, using a Machine Learning-based query executor to traverse at least a part of a data storage and utilize at least a part of an embedding storage, wherein the data storage comprises base data stored in a graph format and the embedding storage comprises supplementary generated data for at least a part of the base data, wherein the supplementary generated data have been generated using Machine Learning; and
   returning a query result to the user based on the uncertainty value and the search strategy.
2. The method according to item 1, wherein the base data are stored in a generic data model supporting graphs, such as a property graph data model or a relational model.
3. The method according to any one of the preceding items, wherein the query result is stored as new data in incomplete knowledge graphs of the data storage.
4. The method according to any one of the preceding items, wherein the uncertainty value comprises a global uncertainty value set at a global level of the query, and/or a local uncertainty value, set at a local level of the query.
5. The method according to any one of the preceding items, wherein the base data in the data storage that are stored in a graph format comprise a plurality of nodes and edges.
6. The method according to any one of the preceding items, wherein the supplementary data in the embedding storage are compressed vector representations of all the nodes of the data storage.
7. The method according to any one of the preceding items, wherein the embedding storage is continuously supplemented with additional supplementary data based on the data storage.
8. The method according to any one of the preceding items, wherein the query has any graph query language format.
9. The method according to any one of the preceding items, wherein the query comprises a plurality of operators that execute on a graph, such as node distance approximates.
10. The method according to any one of the preceding items, wherein the uncertainty value has limits from 0 to 1, and it is preferably less than 0.5, more preferably less than 0.35, even more preferably less than 0.25, most preferably around 0.05 and 0.15, preferably around 0.1.
11. The method according to any one of the preceding items, wherein the uncertainty value determines the amount of processes performed by the computer implemented method on the data storage and on the embedding storage.
12. The method according to any one of the preceding items, wherein the embedding storage comprises supplementary generated data based on incomplete graphs of the data storage.
13. The method according to any one of the preceding items, wherein a cost model is included in the search strategy of the hybrid query optimizer, which reflects the time needed for the method to provide a query under a given uncertainty value.
14. The method according to any one of the preceding items, wherein the hybrid query optimizer enumerates candidate hybrid plans, which find the optimal cost for a given uncertainty value for a specific query provided by the user.
15. A query handling system comprising:
   a server unit for storing data; and
   a processing unit configured to:
      obtain a query;
      choose an optimal way of processing the query by utilizing an uncertainty value provided by the user and a hybrid query optimizer to provide a search strategy;
      based on the search strategy of the hybrid query optimizer, use a Machine Learning-based query executor to traverse a part of a data storage and utilize at least a part of an embedding storage,
   wherein the data storage comprises base data stored in a graph format and the embedding storage comprises supplementary generated data for at least a part of the base data, wherein the supplementary generated data have been generated using Machine Learning; and
      return a query result to the user based on the uncertainty value and the search strategy.

16. A computer program having instructions which, when executed by a computing device or computing system, cause the computing device or computing system to carry out the method of handling queries from a user according to any one of items 1-13.
17. A computer implemented method for handling queries from a user, the method comprising the steps of:
   reading the query by using a query parser;
   choosing an optimal way of processing the query by utilizing uncertainty values provided by the user and a hybrid query optimizer to provide a search strategy;
   based on the search strategy of the hybrid query optimizer, using a Machine Learning-based query executor to traverse at least a part of a data storage and utilize at least a part of an embedding storage, wherein the data storage comprises base data stored in a knowledge graph format and the embedding storage comprises supplementary generated data for at least a part of the base data, wherein the supplementary generated data have been generated using Machine Learning; and
   returning a query result to the user based on the uncertainty value and the search strategy.
18. The computer implemented method of item 17, further configured according to any one of the claims 2-14.

1-14. (canceled)

15. A computer implemented method for handling queries, the method comprising the steps of:
reading a query by using a query parser;
choosing an optimal way of processing the query by utilizing an uncertainty value and a hybrid query optimizer to provide a search strategy;
based on the search strategy of the hybrid query optimizer, using a Machine Learning-based query executor to traverse at least a part of a data storage and utilize at least a part of an embedding storage;
wherein the data storage comprises base data stored in a graph format and the embedding storage comprises supplementary generated data for at least a part of the base data, wherein the supplementary generated data have been generated using Machine Learning; and
returning a query result based on the uncertainty value and the search strategy.

16. The method according to claim 15, wherein the base data are stored in a generic data model supporting graph.

17. The method according to claim 15, wherein the query result is stored as new data in incomplete graphs of the data storage.

18. The method according to claim 15, wherein the uncertainty value comprises a global uncertainty value set at a global level of the query, and/or a local uncertainty value, set at a local level of the query.

19. The method according to claim 15, wherein the supplementary data in the embedding storage are compressed vector representations of all the nodes of the data storage.

20. The method according to claim 15, wherein the embedding storage is continuously supplemented with additional supplementary data based on the data storage.

21. The method according to claim 15, wherein the query has any graph query language format.

22. The method according to claim 15, wherein the uncertainty value determines the amount of processes performed by the computer implemented method on the data storage and on the embedding storage.

23. The method according to claim 15, wherein a cost model is included in the search strategy of the hybrid query optimizer, which reflects the time needed for the method to provide a query under a given uncertainty value.

24. The method according to claim 15, wherein the hybrid query optimizer enumerates candidate hybrid plans, which find the optimal cost for a given uncertainty value for a specific query.

25. The method according to claim 15, wherein the embedding storage comprises supplementary generated data based on incomplete graphs of the data storage.

26. The method according to claim 15, wherein the query comprises a plurality of operators that execute on a graph.

27. The method according to claim 15, wherein the plurality of operators that execute on a graph are node distance approximates.

28. The method according to claim 15, wherein the uncertainty value has limits from 0 to 1, and it is less than 0.5, or less than 0.35, or less than 0.25, or around 0.05 and 0.15, or around 0.1.

29. The method according to claim 16, wherein the generic data model supporting graph is a property graph data model or a relational model.

30. The method according to claim 15, wherein the uncertainty value is provided by a user or by the hybrid query optimizer.

31. The method according to claim 15, comprising the step of choosing one or more search strategies for processing the query by utilizing a hybrid query optimizer, wherein each search strategy is associated with an uncertainty value, and returning a query result and an uncertainty value for each search strategy.

32. A computer implemented method for handling queries, the method comprising the steps of:
reading the query by using a query parser;
choosing one or more search strategies for processing the query by utilizing a hybrid query optimizer, wherein each search strategy is associated with an uncertainty value;
based on each search strategy of the hybrid query optimizer, using a Machine Learning-based query executor to traverse at least a part of a data storage and utilize at least a part of an embedding storage,
wherein the data storage comprises base data stored in a graph format and the embedding storage comprises supplementary generated data for at least a part of the base data, wherein the supplementary generated data have been generated using Machine Learning; and
returning a query result and an uncertainty value for each search strategy.

33. A query handling system comprising:
a server unit for storing data; and
a processing unit configured to:
obtain a query;
choose an optimal way of processing the query by utilizing an uncertainty value provided and a hybrid query optimizer to provide a search strategy;
based on the search strategy of the hybrid query optimizer, use a Machine Learning-based query executor to traverse a part of a data storage and utilize at least a part of an embedding storage,
wherein the data storage comprises base data stored in a graph format and the embedding storage comprises supplementary generated data for at least a part of the base data, wherein the supplementary generated data have been generated using Machine Learning; and
return a query result based on the uncertainty value and the search strategy.

34. A non-transitory computer-readable medium storing instruction that, when executed by one or more processors, cause the one or more processors to carry out the method of handling queries comprising the steps of:
reading a query by using a query parser;
choosing an optimal way of processing the query by utilizing an uncertainty value and a hybrid query optimizer to provide a search strategy;
based on the search strategy of the hybrid query optimizer, using a Machine Learning-based query executor to traverse at least a part of a data storage and utilize at least a part of an embedding storage;
wherein the data storage comprises base data stored in a graph format and the embedding storage comprises supplementary generated data for at least a part of the base data, wherein the supplementary generated data have been generated using Machine Learning; and
returning a query result based on the uncertainty value and the search strategy.
